(19) United States
(12) Patent Application Publication
(10) Pub. No.: US 2013/0115412 A1
(43) Pub. Date: May 9, 2013

(54) POLYURETHANE LAMINATES MADE WITH A DOUBLE BELT PRESS

(71) Applicant: Havco Wood Products LLC, Scott City, MO (US)

(72) Inventor: Gopalkrishna PADMANABHAN, Fenton, MO (US)

(73) Assignee: HAVCO WOOD PRODUCTS LLC, Scott City, MO (US)

(21) Appl. No.: 13/668,211

(22) Filed: Nov. 2, 2012

Related U.S. Application Data
(60) Provisional application No. 61/555,772, filed on Nov. 4, 2011.

(51) Int. Cl. B29D 7/00; B32B 5/10; B32B 5/12; B29C 43/24

(52) U.S. Cl. CPC B29D 7/00; B29C 43/24; B32B 5/10; B32B 5/12
USPC 428/113; 156/176; 156/437

(57) ABSTRACT

A fiber reinforced composite laminate with fibers generally oriented along two major axes and having a polyurethane resin matrix suitable for reinforcing wood based substrates such as trailer/container flooring, glulams, plywood, particle boards, laminated veneer lumber, and oriented strand board, is provided. The laminate is produced by pulling the fibers through a resin injection box, where a polyurethane resin is injected into the box to wet the fibers. The polyurethane resin wetted fiber layer is then covered with a release media on the top and bottom sides of the layer. The sandwich of fiber, resin and release media is fed to a double belt press capable of applying pressure and heat to consolidate and cure the laminate. The laminate thus made can be thinner than 0.080 inch and provides excellent flatness compared to pultruded thin laminates.

### CROSS-REFERENCE TO RELATED APPLICATIONS

This application claims the benefit of U.S. Provisional Application Serial No. 61/555,772, filed on Nov. 4, 2011.

### BACKGROUND OF THE DISCLOSURE

1. Field of Disclosure

A method of manufacturing a thin polyurethane laminate using a double belt press and resin injection box.

2. Description of Related Art

Thermoset polyurethane (PU) has been successfully used to make fiber reinforced composite profiles by the pultrusion process. The product brochure for RIMLINE® polyol and SUPRASEC® MDI isocyanate from Huntsman Corporation describe the pultrusion process and the advantages of using polyurethane in this process. Bayer MaterialScience AG offers BAYDUR® PUL 2500 polyurethane for making window frame components using the pultrusion process. U.S. Pat. No. 8,273,450 to Green describes a unidirectional fiber reinforced thermoset polyurethane material for wood products where the fiber to resin ratio is 50% to 70%.

The thermoset polyurethane resin normally uses two components, namely a polyol and an isocyanate. One-component polyurethane resins are also available. The resin mix can have additional constituents such as filler, colorant, internal mold release agent, and wetting agent.

The pultrusion process works well to make profiles of different cross-sections and thicker flat sheets higher than 0.125 inch. The pultrusion process is unsuitable for making thin laminates, where the laminate has a thickness less than 0.125 inch and especially less than 0.080 inch.

There are several reasons for this difficulty. In the pultrusion process, resin wetted fibers are pulled through a stationary heated die. Thin laminates cured in a stationary die are prone to damage from the shearing action of the inner surface of the pultrusion die. This phenomenon is a limitation of the pultrusion process. Surface finish of the laminate is affected. Fiber rovings can move out of their original aligned location in the die and cause non-uniform thickness of laminate. The laminate made by the pultrusion process tends to be warped due to the uneven residual fiber stress. Warping of thin laminates can be in the form of lifting of the corners of the laminate and cupping in the middle of the laminate. Thin polyurethane laminate made by pultrusion in the size of 3 feet long and 12 inches wide at the thickness of about 0.050 inch can have one or more corners of the laminate lifting up by about ½ inch or more. The use of reinforcing fibers in the longitudinal and transverse axes of the laminate tends to exacerbate the flatness problem because of uneven residual stress in the fibers after the curing process in the pultrusion die. An internal release agent has to be mixed with the resin in order for the cured part to release from the die. The release agent can be very costly compared to the cost of the resin itself, but it does not add to the structural properties of the laminate. Further, the rate of production in pultrusion is limited by the length of the die. Increasing the length of die to increase pull speed or production speed causes additional frictional force in the die and leads to further quality issues of laminate.

A resin injection box is typically used in pultrusion of polyurethane composites. The box can be made of plastic or metal. It has a plate at one end with many holes or eyelets for threading and aligning the fiber rovings or tows. A fabric made of the fiber or a mat can be introduced into a slot in the plate. The dry fiber reinforcement then enter a hollow chamber of the injection box. The chamber has a gradual taper along the length of the box. One or more ports are provided in the box to inject the PU resin into the chamber and wet the fibers. The tapered chamber provides a squeeze action to hold back part of the resin carried by the fibers as they are pulled out of the box. The primary purpose of the resin injection box is to wet the fibers with excess resin.

In the pultrusion process, the resin injection box is attached to a die made of steel or other metals. The first section of the die is water cooled. This section sets the final ratio of the fiber and resin by restricting the flow of resin. The second section of the die is heated and the heat is transferred to the resin wetted fibers. The curing of resin takes place in the heated section. Due to the restricted cross-sectional area of the die, the glass fibers abrade on the surface of the die chamber and cause wear. To overcome this problem, the inner surface of the die chamber is typically chrome plated.

When making laminates thinner than 0.080 inch by the pultrusion method, many new problems are seen. The space in the die chamber is highly restrictive and there is a large number of fiber rovings rubbing on the die surface relative to the total volume of fibers in the final laminate to be cured. The rovings can be displaced, carry uneven tension loads and sometimes even break off due to the friction inside the die. The problem is exacerbated when using larger rovings or bundles of fiber because a large roving when displaced has a more magnified effect on the laminate quality. Finer rovings may help to achieve more uniformity in the pultrusion product quality, but they are more costly than the larger rovings per pound of material.

It is desirable to use rovings of size 113, 250, 450 or 675 yield or a combination of them, rather than using 900 yield or higher yield rovings (finer rovings) to reduce material cost. Yield of roving is the linear yards of roving per pound of roving. For example, 900 yield roving is thinner or finer than 113 yield roving, which is coarse. Tex is also used to designate the size of rovings, which is the mass of a roving over 1000 linear meters. For example, a roving with 900 yield designation has Tex of 550 and a roving with 207 yield designation has a Tex of 2400. Fewer heavier rovings are easier to handle, which also reduces the size of the fiber creel setup. However, the fiber tension has to be more uniform and the rubbing action on the die has to be reduced to make a thin laminate that has good flatness.

Fiber reinforced laminates can be bonded to wood floor boards for use in trailers using reactive polyurethane hotmelt adhesive, which is nearly 100% solids based and does not have water as a carrier for the solids (U.S. Pat. No. 6,179,942 to Padmanabhan). This adhesive has low green strength of bonding (in the uncured state) than its bonding in the fully cured form. When bonding warped fiber reinforced laminate to wood using the hotmelt adhesive, the laminate tends to debond from the wood substrate soon after bonding. Reactive hotmelts normally are cured at ambient conditions over 24 to 72 hours. For consistent bonding of the laminate, it is preferable to limit the corner lifting of the laminate to less than 0.5 inch so that the laminate does not debond from the substrates when reactive hotmelts are used as an adhesive. There is thus a need to make thin and flatter polyurethane laminates for reinforcing substrates using hotmelt adhesives.

Another need exists in terms of using lower cost adhesives to bond thermoset polyurethane laminate to wood based panels such as plywood, particle boards, and oriented strand boards. The reactive polyurethane hotmelt adhesives cost more than $3.50 per pound of material. Typically, about 20 grams of adhesive is used per square foot for bonding fiber reinforced laminate to wood. This leads to a cost of $0.15 per square foot for hotmelt adhesive. Conventional water-based wood adhesive, such as resorcinol, melamines, phenolics, polyvinyl acetate and urea formaldehyde have about 30% to 50% by weight of water in the adhesive formulation. They do not provide good bonding between typical fiber reinforced laminates and wood. It is because of the water present in the adhesive that evaporates upon heating the substrates in a hotpress to cure the glue. Part of the evaporated water is absorbed by wood through its porous structure and its affinity for water. Since a fiber reinforced laminate does not allow the steam to escape, the back pressure from the steam affects the bond strength. There is a need to be able to bond thin polyurethane laminate to wood using conventional adhesives in a hotpress and overcome the issue of low bond strength caused by steaming of water.

### SUMMARY OF THE DISCLOSURE

The continuous double belt press is known in the art for making fiber reinforced epoxy laminate for reinforcement applications in ski, snowboard, printed circuit boards, and wood flooring for trailers. Sandvik Processing Systems (Fellbach, Germany) is a leading provider of steel belt presses worldwide. This press has a top steel belt and a bottom steel belt and both belts are driven at about the same linear speed. The belts can be heated and cooled. The belts can apply heat and pressure on a substrate while the substrate is transferred on the bottom belt and pressed down by the top belt. Pressure is applied by means of circulating rollers on chains in contact with the top and bottom belts. Heated platens in contact with the circulating rollers transfer heat and pressure to the belts. The heat helps to cure a thermoset resin of the substrate, while the pressure consolidates the substrate material. To make a fiber reinforced laminate, the fibers are typically wetted with an epoxy resin in an open bath or impregnator. The epoxy resin can also be coated on the bottom steel belt with a slot die coating and then the dry fibers are applied on the epoxy resin layer for impregnation and wetting of the fibers with the epoxy resin. The wetted fibers are covered with a release ply on the top and bottom and transferred to the double belt press. Under the applied heat and pressure of the belt press, the glass reinforced epoxy laminate can be made by the conventional double belt pressing process. Typically, the glass/epoxy laminate is close to full consolidation with little or no voids or entrapped air due to the pressure applied by the double belt press.

Unlike the epoxy resin, thermoset polyurethane resin is not suitable for impregnating the fibers using an open bath or slot die coating of belt. This is because polyurethane resins are fast reacting and the isocyanate component of the resin mix can react with any moisture from the atmosphere or the fibers, thus forming carbon dioxide and polyurea compounds. In places with high humidity, open systems suitable for impregnation of fibers with epoxy is problematic when using polyurethane.

The resin injection box is the most suitable way for impregnating fibers with thermoset polyurethane. However, such an apparatus has not been used in conjunction with a double belt press. A resin injection box to wet the fibers and a short die to set the fiber to resin ratio is useful in the double belt laminating process. A polyurethane resin can be used to make thin laminates using the double belt press machine. Further, bidirectional reinforced laminate of polyurethane resin, which is particularly useful for reinforcing members subject to bending stress in both the longitudinal and transverse directions of the members or to twisting forces can be made by combining a resin injection box, a short die, and a double belt press.

One of the objects of this disclosure is the processing of fiber reinforced polyurethane laminates using a double belt press, a resin injection box for wetting of the fibers with the resin, and a die to control the ratio of the fiber to resin matrix.

Another object of this disclosure is the manufacture of thin polyurethane laminates that are less than 0.080 inch in thickness with controlled glass weight fraction of laminate between about 50% to about 85%, and more preferably between about 65% to about 80%.

Yet another object of the disclosure is to tailor the properties of the polyurethane laminate to provide a tensile strength along a longitudinal major axis of the laminate that is up to about 15 times the tensile strength along a transverse major axis of the laminate.

Still another object of the present disclosure is to make flat reinforced polyurethane laminate, wherein the laminate lifts at the corners to less than ½ inch and cups at the middle to less than ½ inch. These flatter laminates are particularly useful for bonding to substrates using a reactive hotmelt adhesive having low green/uncured bond strength.

Another object of the disclosure is a thermoset polyurethane fiber reinforced laminate with controlled porosity or void content. By introducing a controlled amount of moisture to the uncured polyurethane, some of the isocyanate can be made to react with the moisture and form carbon dioxide. This gas is entrapped in the laminate and also forms voids, which are essentially devoid of the resin matrix. These voids on the surface of the laminate help to use a conventional wood adhesive when bonding a thermoset polyurethane laminate to wood. The voids help to absorb or transfer the steam generated by the water based wood adhesive upon heating for curing the glue. Further the voids provide spaces for the wood adhesive to mechanically attach to the fiber reinforced polyurethane laminate.

An object of the disclosure is the introduction of moisture into the polyurethane resin in a distributed and controlled manner. By applying a silicone coated release paper having inherent moisture in the paper to the polyurethane wetted reinforcement, the moisture from the paper can be made to react with the isocyanate to release carbon dioxide gas. This provides voids in the resin, especially at the surface of the laminate. Alternatively, the moisture in the fiber can react with the isocyanate to provide a porous laminate.

It is another object to make a polyurethane laminate with voids close to one or both surface of the laminate with as little or no voids in remaining volume of the laminate. In this case, some of the fibers are dried by blowing hot air or other means. The dry fibers are used in the core of the laminate or not used at one of both surfaces of the laminate. The fibers used at a surface can have some residual moisture that helps to create voids at the surface. Natural fibers such as cotton, hemp and jute with residual moisture or the like type of fibers are suited for the making the surface of the polyurethane laminate with voids. Another option is to use a Kraft paper, tissue paper or a suitable resin absorbing cellulose fiber based paper on a surface of the polyurethane wetted fibers. The paper can become an integral part of the laminate by absorbing the resin and creating the surface of laminate with voids. Alternatively, a silicone coated plastic film (e.g., MYLAR®) is used as a release ply, which is essentially dry and creates surfaces with little or no voids. A combination of moisture carrying release paper and dry plastic release film can be used on two sides of the wetted fibers to obtain different surface properties in terms of voids. The surface with voids is useful to bond the thermoset polyurethane laminate to wood substrates with any adhesive, including water based conventional wood adhesives. The well consolidated opposite surface of laminate with release film is better for external appearance and strength properties. By applying dry release film or fully dry paper on both sides of the wet reinforcement, a highly consolidated polyurethane laminate can be made. Thus, it is an object of this disclosure to create distributed voids in the polyurethane laminate.

Further, it is another object to alter the surface of the laminate by sanding, abrading, scuffing or treating with corona or chemicals to improve the bonding characteristics of the surface of laminate to other substrates for the purpose of strengthening of the surface.

Another object of the present disclosure is a fiber reinforced polyurethane laminate for adhesively bonding to substrates to strengthen such substrates, the laminate having a first a second major axes, the first axis disposed along a longitudinal dimension of the laminate and a second axis disposed along a transverse dimension of the laminate, the laminate further having two opposed surfaces and a thickness between the surfaces. The fibers are generally oriented along both major axes of the laminate to provide a bi-directional orientation of fibers and fiber weight fraction between 50% to 80% and having a first tensile strength along a first axis and a second tensile strength along a second axis, wherein the first tensile strength is up to 15 times the tensile strength of the laminate along the second axis. This type of laminate is useful to strengthen wood based products such as plywood, trailer floor boards, particle boards, oriented strand boards or any plank- or plate-like structures. The laminate can also be sued to make sandwich structural elements using the laminate as a skin on one or both sides of the sandwich. The core can be balsa wood, rigid foam, honeycomb materials or the like.

### BRIEF DESCRIPTION OF THE DRAWINGS

FIG. 1 is a schematic illustration of the process to make a bi-directional fiber reinforced polyurethane laminate using a resin injection box and continuous double belt press.

FIG. 2 is a schematic illustration of the resin injection box and die to wet and impregnate the fibers with polyurethane resin.

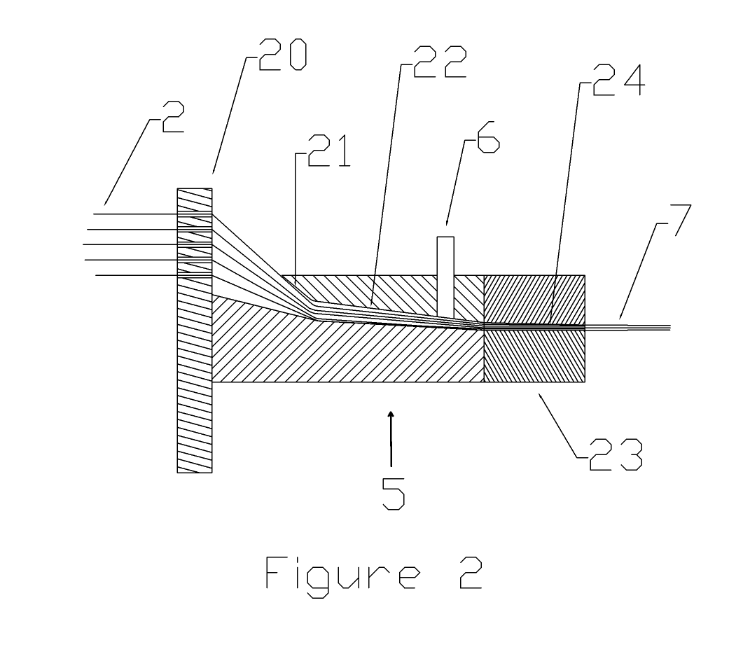

FIG. 3 is a schematic illustration of the process to make a bi-directional fiber reinforced polyurethane laminate using a resin injection box and continuous double steel belt press with dual re-circulating roller sections.

FIG. 4 is a schematic illustration of the process to make a bi-directional fiber reinforced polyurethane laminate using a resin injection box and continuous double steel belt press with convective heating zones for belts.

FIG. 5 is a schematic illustration of the process to make bi-directional fiber reinforced polyurethane laminate using multiple resin injection boxes.

FIG. 6 is a schematic illustration of a bi-directional fiber reinforced polyurethane laminate.

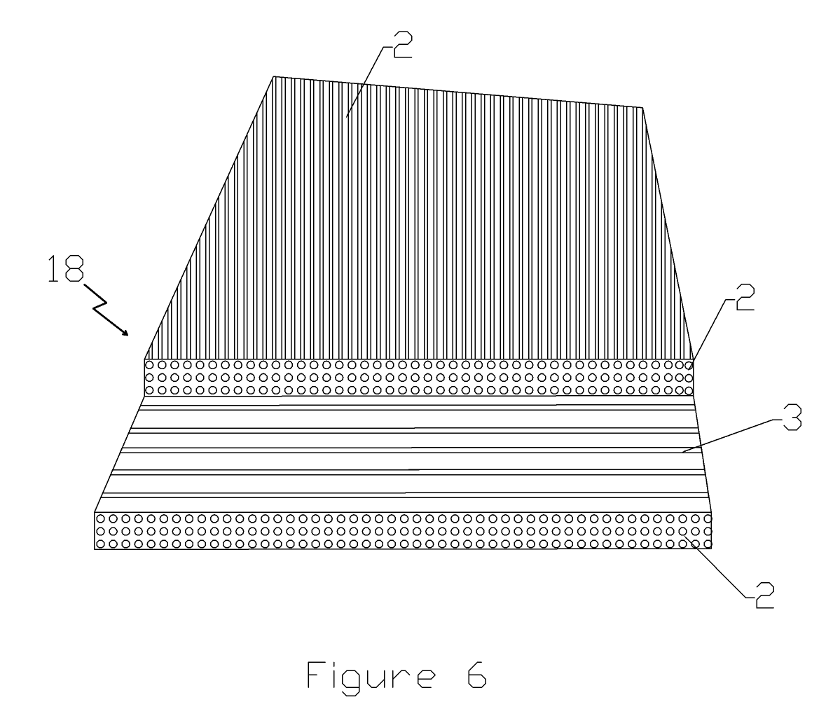

### DETAILED DESCRIPTION OF THE DISCLOSURE

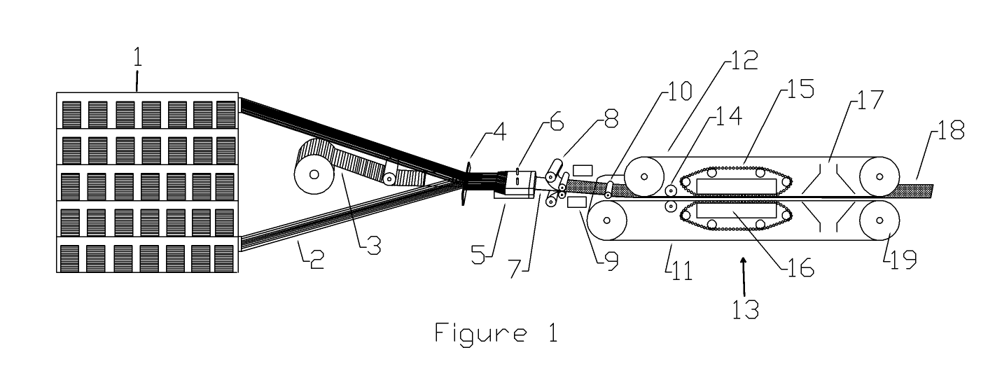

FIG. 1 shows an schematic diagram of the process of making a bi-directional polyurethane laminate using the double belt press. The rovings or tows 2 are pulled off packages of fiber from a creel 1. One or more fiber mats or fabric 3 is unwound from a roll. The mat can be a woven roving or stitched fabric having fibers oriented in one or more directions. For example, the woven roving can have a plain weave wherein 50% of the fibers of the mat are approximately along the longitudinal machine direction and the remaining 50% of the fibers in the mat are approximately in a transverse direction. Alternatively, the fabric can be uni-weft, where all the fibers are approximately in the transverse direction except for fibers used for the stitching the transverse fibers together to form the fabric. Other orientations of the fibers in the mat are at ±45° to the machine axis. For the purpose of this disclosure, a mat shall be understood to be any woven, non-woven, stitched, stitch-bonded reinforcement in the form of a layer other than the rovings. By using rovings in the machine direction in combination with one or more mats, bi-directional polyurethane laminate can be made. Preferably, the fabric or mat is used as a middle layer with rovings on top and bottom of the middle layer. Another arrangement can have a mat at the top and bottom of a core of unidirectional rovings. The fibers are arranged in a mostly symmetrical pattern relative to the middle plane of layup to obtain good flatness of the cured laminate.

The fibers may be glass, carbon, aramid (KEVLAR®), basalt, polyethylene (SPECTRA®), or any other synthetic reinforcing fibers. Alternatively, the fibers can be derived from natural sources such as hemp, jute, cotton, kenaf, flax, or the like materials. The fibers may have some residual moisture retained from a prior process or from absorption of moisture from the ambient environment. The moisture may be used selectively to make a polyurethane laminate with voids or the fibers may be dried using hot air or other means to make a laminate with higher density. A dryer can be located after fiber creel 1 to remove residual moisture from the fibers and mat. The rovings and mat are aligned and guided through a suitable alignment plate 4 with eyelets and slots. The fibers are then pulled through a resin injection box 5. The resin injection box has one or more ports 6 to supply polyurethane resin for wetting the fibers. The polyurethane resin may be pumped form a meter mixer or suitable dosing equipment. Excess resin can be re-circulated into the injection box.

The essential function of the resin injection box is to wet the fiber rovings and mat. The rovings and mat are passed through an alignment card 20, and then pulled through one or more tapered chambers 21, 22 in the resin injection box. The tapered chamber allows for resin to be available for wetting the rovings and mat at the inlet side of the box. The narrowing of the chamber limits the amount of resin that can be carried by the fibers before the fibers enter a last section of the box, which is designed to act like a resin metering die 23. The purpose of the die section is to more precisely control the amount of resin carried by the fiber and to create a more uniform tension on the rovings and mat across the width of the slot opening in the die. At least a part of the die chamber 24 is more restrictive than the tapered chamber 22 of the injection box. The die chamber may have a small taper to ease the passage of wetted fibers, but the slot opening is designed to allow the required amount of resin to exit the die with the fibers and control the fiber to resin weight ratio. The fiber content of the laminate can be controlled between 50% to 85% by using suitable slot dimensions for the die. The injection box can be made of plastic such as polyethylene or a metal such as steel and the steel may be chrome plated for wear resistance. The slotted die 23 can be an integral part of the box. The die can also be a separate piece that is made of steel or another metal and attached to main body of the box. Further, the inside chamber of the die may be coated with chromium or other wear resistant material for increased life during production of the laminate.

The wetted fibers 7 are pulled out of the resin injection box and metering die and the required fiber to resin weight ratio is set by the dimensions of the slot in the die. The top and bottom surface of the wetted fibers are covered with release media or ply 8. For example, a silicone coated paper is suitable for release from the cured laminate. A TEFLON® coated fabric can also be used as a release media. Due to the high cost of TEFLON® coated fabric, suitable unwind and rewind equipment may be needed for reuse of the TEFLON® coated fabric in the lamination process. Silicone coated MYLAR® plastic film is another option for the release media. Alternatively, decorative layers may be used as a covering media to provide a needed finish to the laminate. The decorative layer can be non-releasable or bonded to the polyurethane laminate. Release paper made with cellulose fibers can have inherent moisture. This moisture can react with the isocyanate component of the polyurethane resin to form gas, which in turn can provide voids in the polyurethane matrix of the laminate. The MYLAR® film has little or no moisture and it provides a relatively more solid surface finish and highly controlled laminate. Radiant heat may be applied to the layup of resin wetted fibers and release ply using heat lamps or infrared (IR) heaters 9. The fibers are then aligned due to tension created by rubbing of the fibers on the inner surfaces of the metering die. Additional tension can be applied to the fibers before the fibers enter the resin injection box 5.

The layup of wetted fibers and release plies are placed on the extended bottom steel belt 11 of the double belt press 13. One or more nip rollers 10 may be applied to the layup to iron out any entrapped air and help the impregnation of fibers. Compressible ropes of jute, cotton, rubber, foam or another suitable material are laid at the lateral edges of the layup to create a dam and stop the lateral squeeze out of resin in the press. The heat applied to the sandwich helps to lower the viscosity of resin and impregnate the fibers. The heat also expands the entrapped air and the nip roller can more easily remove the heated expanded air. The layup is pulled into the double belt press by the top belt 12 and bottom belt 11, which are circulating endless steel belts kept under tension between large drums 19 at the ends of the belt loops. The press has at least one section to apply heat and pressure on the layup. Heat may be applied by convective, radiative or conductive means. Convective heat can be applied by circulating hot air adjacent to the belts. Radiative means can involve the use of IR heaters or lamps. Conductive means can include oil heated platens 16. Pressure is applied on the belts and the resin wetted fibers by means of circulating rollers on chains 15. The circulating rollers are in contact with the platens and belts. Typical average pressure needed to consolidate the laminate is 20 to 200 psi. Additional nip rolls 14 can also be used to apply pressure; however, this pressure is limited to the contact area of the rollers with the belts and so it acts for a short time on the substrate compared to the circulating rollers, which acts for a longer time depending on the length of the roller chains and platens. The circulating roller section applies oscillating pressure between an upper and a lower pressure values on the substrate over the length or section of roller chains, while nip rollers apply instantaneous pressure in a small section of contact with the belt. The combination of heat and pressure cures the resin and forms a fiber reinforced polyurethane composite laminate. The double belt press may also have a cooling section 17 to remove some of the heat from the laminate, which helps to strengthen the laminate 18. The release ply can be peeled off the laminate at the exit end of the double belt press. A decorative ply bonds to the laminate and it is not removed. The laminate may be sawed to narrower widths as needed. One or both surfaces of the laminate may be altered for improved bonding of the laminate to other substrates for the purpose of strengthening the substrates.

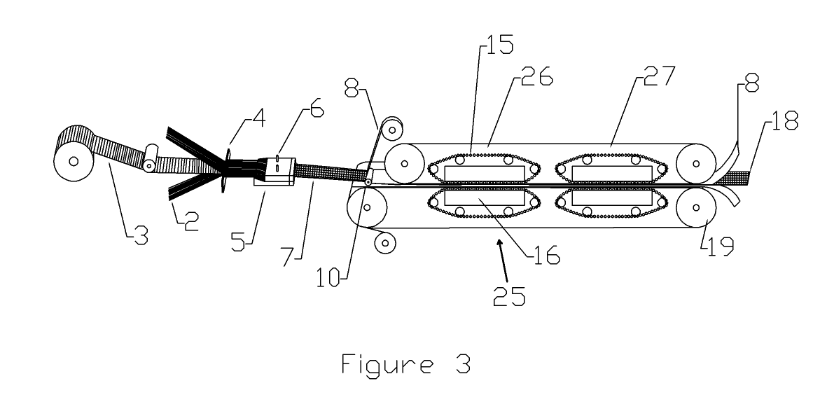

An alternative arrangement of the setup to produce a bi-directional thermoset polyurethane laminate is shown in FIG. 3. The double belt press 25 has a first section of circulating rollers 26 and a second section of circulating rollers 27. The first section can be used for heating the layup while the second section can be used for cooling of the cured laminate with both sections applying pressure.

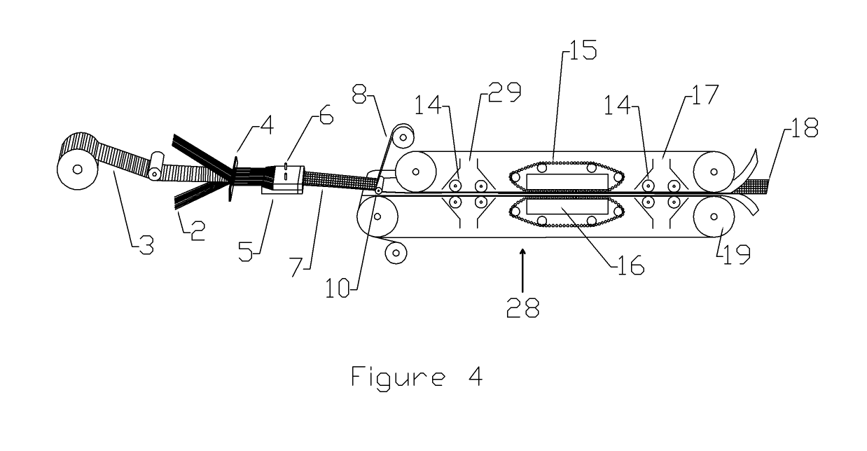

Another arrangement of the setup to produce a thermoset polyurethane laminate is shown in FIG. 4. The double belt press 28 has a heating zone 29 where the belt is heated by convective or radiative means. Multiple sets of nip rollers 14 are used to apply instantaneous pressure on the layup and to keep the belts in good contact with the layup for heat transfer.

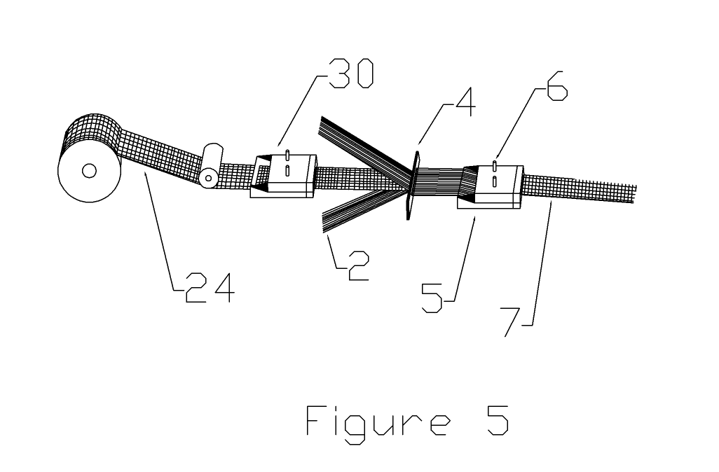

When the mat has more than 20% of the total fiber used to make the laminate it can be useful to wet the mat separately with the resin to obtain good wet out of the mat. This can be accomplished by using multiple resin injection boxes with dies as shown in FIG. 5. For example, a mat with fibers oriented in two directions is pulled through a first resin injection box 30 with a die and combined with the non-wetted rovings at the outfeed side of the alignment plate 4. The combination of wetted mat and rovings are then pulled through a second resin injection box 5 and die. Proper wet out of the fibers is essential to obtain higher strength and mechanical properties of the laminate.

Experiments were conducted with a setup schematically shown in FIG. 4. Both glass fiber rovings and a uni-weft stitched fabric having all of the glass fibers in the transverse direction were used to make a thermoset polyurethane laminate 18. The construction of the laminate 18 was symmetric with unidirectional rovings 2 on top and bottom of a uni-weft fabric 3. Two-component polyurethane resin comprising a polyol and isocyanate components was pumped by a meter-mixer to the resin injection box. Thermoset polyurethane laminates of different attributes were made and their properties were determined by testing. The following details exemplify the results of using a silicone coated paper and silicone coated MYLAR® film for release plies.

### EXAMPLE 1

Polyol and isocyanate were obtained from Bayer MaterialScience (Pittsburgh, Pa.). The glass rovings were purchased from Johns Manville. The rovings were 2400 Tex, which is a coarse rovings and has a lower cost. 160 roving ends were threaded through the alignment card 4 with half of the rovings above a middle slot in the card and the other half of the rovings below the slot. A uni-weft fabric made by Saertex Group (Huntersville, N.C.), was threaded through the slot. The glass fabric had a weight of 169 grams per square meter with the glass fibers oriented in the transverse direction to the machine axis. The polyurethane wetted fibers were covered by silicone coated paper having a certain residual moisture and pulled by the double belt press at a speed of 0.8 meter per minute. The slot of the die 23 was 305 millimeters (mm) wide and 1 mm in height. The roller 10 was not used. The heat zone 29 was kept at 100° C. The platens 16 in the circulating roller section of press was kept at about 220° C. The thermoset polyurethane laminate was formed by curing the resin under the oscillating pressure applied by the circulating rollers and steel belts. The average pressure is estimated to be about 3 bars. The cured laminate has a thickness of 1.4 mm. Samples of the laminate were tested and found to have the following properties.

Tensile strength (warp or longitudinal direction—80,000 to 87,000 psi.

Tensile strength (weft or transverse direction)—8,000 to 10,600 psi.

Density—1.5 to 1.65 grams per cubic centimeter.

Expected density for full consolidation without voids—1.9 grams per cubic centimeter.

Water absorption rate—1.9% to 2.6% weight change in 72 hours.

Flatness—the edges and corners of the laminate lifted by less than 0.5 inch compared to the middle plane of the laminate.

Due to the moisture in the release paper which reacted with the isocyanate component of the polyurethane, the cured laminate had lower than the expected density (1.9 grams per cubic centimeter). The lower density was mostly due to voids in the resin matric. The voids can be exposed upon sanding or abrading the surface of the laminate. These voids can be useful when bonding the polyurethane laminate to wood based products using a lower cost water-based wood adhesive in a hotpress. The voids help to absorb and transmit the steam from the water-based glue upon heating in the hotpress and also provides sites for the solids in the glue to attach to the laminate and to the wood substrate. It is also useful to incorporate the polyurethane laminate as a reinforcing ply along with the conventional wood plies in the manufacture of reinforced plywood using a hotpress and conventional wood adhesives.

### EXAMPLE 2

The materials and process of Example 1 were similarly used with the following changes. 40 rovings of size 1200 Tex (finer than 2400 Tex) were used as a topmost layer and another 40 rovings of size 1200 Tex were used as the bottommost layer of the fiber layup. The middle core layer comprised the 160 rovings of size 2400 Tex as in Example 1. The fabric was uni-weft type with a weight of 186 grams per meter square. The release plies on top and bottom of the wet fibers were silicone coated MYLAR® film. The MYLAR® film was thought to have little or no moisture. The roller 10 was used to better consolidate the wet layup and remove entrapped air. The glass fibers were heated with hot air before feeding to the resin injection box. The average pressure was estimated to be 4 bars in circulating roller zone. The cured laminate had a thickness of about 1.4 mm. Samples of the laminate were tested and found to have the following properties.

Tensile strength (warp or longitudinal direction—105,000 to 120,000 psi.

Tensile strength (weft or transverse direction)—7,400 to 9,000 psi.

Density—1.84 grams per cubic centimeter.

Expected density—1.9 grams per cubic centimeter.

Water absorption rate—0.29% weight change in 72 hours.

Flatness—the edges and corners of the laminate lifted by less than 0.5 inch compared to the middle plane of the laminate.

Higher strength and higher density of the polyurethane laminate were obtained by using a silicone coated MYLAR® film as the release plies. Due to reduced void content in the laminate, relatively very little water was absorbed by the laminate after soaking for 72 hours. Further, the warp strength was higher.

The above examples show that by introducing a release paper ply with residual moisture content, the properties of the resulting polyurethane laminate can be changed. The use of natural fibers, including, but not limited to, cotton, jute, and hemp can provide the same effect. These materials can be selectively used on the surface layer to provide a controlled amount of voids to enhance the bonding characteristics of the polyurethane laminate.

The present disclosure provides a bi-directional polyurethane laminate, which is useful for strengthening of substrates along multiple axes of the substrates by adhesively bonding the laminate to the structure. Voids can be introduced in a controlled manner by introducing fibers and layers having residual inherent moisture. Wood based structures such as trailer flooring, plywood panels, oriented strand boards, and other panels and plate-like structures made of any material which is weaker than the thermoset polyurethane can be strengthened. Sandwich structural elements with foam, balsa or honeycomb cores and fiber reinforced polyurethane skins can be made. This type of reinforcing of weaker substrates is useful in applications where the structure is subjected to bending stress in more than one axis of the structure. It is also useful in case of twisting and shearing forces applied on the structure, where the bi-directional laminate having strength along two directions provides significant improvement over the un-reinforced structure.

The present disclosure also includes the use of a resin injection box to wet the fibers with polyurethane resin and control the ratio of fiber to resin content with a die and further apply a covering or release media to the wet fibers and finally cure the resin in a continuous double belt press with at least one heat and pressure application zone. Yet further, the present disclosure includes a combination of the resin injection box and the double belt press to make fiber reinforced polyurethane laminate with bi-directional strength of laminate and a higher degree of flatness for thin laminates than obtained by using the pultrusion process.

As used in this application, the word “about” for dimensions, weights, and other measures means a range that is ±10% of the stated value, more preferably ±5% of the stated value, and most preferably ±1% of the stated value, including all subranges therebetween.

It should be understood that the foregoing description is only illustrative of the present disclosure. Various alternatives and modifications can be devised by those skilled in the art without departing from the disclosure. Accordingly, the present disclosure is intended to embrace all such alternative, modifications, and variances that fall within the scope of the disclosure.

What is claimed is:

1. A fiber reinforced polyurethane laminate for adhesively bonding to a substrate to strengthen such substrate, the laminate comprising:
a first major axis and a second major axis, wherein the first major axis is disposed along a longitudinal dimension of the laminate and the second major axis is disposed along a transverse dimension of the laminate;
a first surface and a second surface, wherein the first surface is opposite the second surface, and wherein the first surface and second surface have a thickness therebetween;
a plurality of reinforcing fibers, wherein the fibers are generally oriented along both the first major axis and the second major axis to provide a bi-directional orientation of fibers; and
a thermoset polyurethane polymer matrix,
wherein the laminate has a fiber weight fraction between about 50% and about 80%,
wherein the laminate has a first tensile strength along the first major axis and a second tensile strength along a second axis, and
wherein the first tensile strength is up to 15 times greater than the second tensile strength.

2. The fiber reinforced polyurethane laminate of claim 1, wherein the reinforcing fibers are selected from the group consisting of: glass, carbon, aramid, polyethylene, basalt, jute, cotton, hemp, and any combinations thereof.

3. The fiber reinforced polyurethane laminate of claim 1, wherein either of the first surface or the second surface of the laminate, or both the first and second surfaces of the laminate, is sanded, abraded, scuffed, or corona treated.

4. The fiber reinforced polyurethane laminate of claim 1, wherein the substrate is a wood based substrate selected from the group consisting of: plywood, particle board, trailer floor board, plank, plate, and any combinations thereof.

5. The fiber reinforced polyurethane laminate of claim 1, wherein the substrate comprises a core material selected from the group consisting of: rigid foam, balsa, honeycomb, and any combinations thereof.

6. The fiber reinforced polyurethane laminate of claim 1, wherein the polyurethane polymer matrix further comprises void spaces having no resin matrix.

7. The fiber reinforced polyurethane laminate of claim 1, wherein the laminate, when bonded to a substrate, strengthens the substrate.

8. A method of making a fiber reinforced polyurethane laminate for adhesively bonding to a substrate to strengthen the substrate, the laminate comprising a first major axis and a second major axis, wherein the first major axis is disposed along a longitudinal dimension of the laminate and the second major axis is disposed along a transverse dimension of the laminate; a first surface and a second surface, wherein the first surface is opposite the second surface, and wherein the first surface and second surface have a thickness therebetween; and a plurality of reinforcing fibers, wherein the fibers are generally oriented along both the first major axis and the second major axis to provide a bi-directional orientation of fibers, the method comprising:
pulling the fibers through a box;
injecting a polyurethane resin into the box to wet the fibers;
pulling the resin wetted fibers through a die to control the amount of resin carried by the fibers to form a resin wetted fiber layer with an upper side and a lower side;
applying a release media to the upper side and the lower side of the resin wetted fiber layer to form a layup; and
feeding the layup to a double belt press,
wherein the double belt press applies heat and pressure on the resin wetted fibers to form the fiber reinforced polyurethane laminate.

9. The method of claim 8, wherein the reinforcing fibers of the laminate are selected from the group consisting of: glass, carbon, aramid, polyethylene, basalt, jute, cotton, hemp, and any combinations thereof.

10. The method of claim 8, wherein either of the first surface or the second surface of the laminate, or both the first and second surfaces of the laminate, is sanded, abraded, scuffed, or corona treated.

11. The method of claim 8, wherein the laminate formed by the method, when bonded to a substrate, strengthens the substrate.

12. The method of claim 8, wherein the substrate is a wood based substrate selected from the group consisting of: plywood, particle board, trailer floor board, plank, plate, and any combinations thereof.

13. The method according to claim 8, wherein the substrate comprises a core material selected from the group consisting of: rigid foam, balsa, honeycomb, and any combinations thereof.

14. A machine system for making a fiber reinforced polyurethane laminate comprising:
a creel for fiber rovings;
one or more unwinds for fiber mats;
a fiber tensioning device;
a resin injection box for wetting fibers with a resin and controlling the fiber-to-resin weight ratio; and
a double belt press, for curing the resin under heat and pressure.

15. The machine system of claim 14, wherein the fiber rovings are selected from the group consisting of: glass, carbon, aramid, polyethylene, basalt, jute, cotton, hemp, and any combinations thereof.

16. The machine system of claim 14, wherein the double belt press further comprises one or more pressing zones having circulating rollers.
